(19) United States
(12) Patent Application Publication
(10) Pub. No.: US 2010/0050904 A1
(43) Pub. Date: Mar. 4, 2010

(54) PRODUCTION OF FINELY DIVIDED PIGMENTS

(75) Inventors: Joachim Jesse, Weisenheim (DE); Benno Sens, Neustadt (DE); Richard van Gelder, Speyer (DE); Matthias Klueglein, Ludwigshafen (DE); Wolfgang Best, Freinsheim (DE); Rainer Henning, Freinsheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/595,694

(22) PCT Filed: Apr. 10, 2008
(86) PCT No.: PCT/EP2008/054319

§ 371 Date: Oct. 13, 2009

(30) Foreign Application Priority Data
Apr. 13, 2007 (EP) 07106102.2

(51) Int. Cl. C09B 27/00; C08K 5/00; C08K 5/3415; C09B 48/00

(52) U.S. Cl. 106/496; 106/493; 106/498; 106/497

(57) ABSTRACT

The invention relates to a methods finishing an organic pigment by dissolving or dispersing the pigment in a mineral acid and crystallizing the pigment from the solution or dispersion by mixing with an aqueous diluent in the presence of a crystallization modifier constituted by a sulfonate-functional condensation product of a naphthalenesulfonic acid and at least one aliphatic aldehyde having 1 to 6 carbon atoms, and then isolating the pigment as a solid, wherein the crystallization modifier is present in the aqueous diluent.

The invention relates to a method of finishing organic pigments using sulfonate-functional condensation products based on naphthalenesulfonic acid as crystallization modifiers. By “sulfonate-functional” is meant, below, the presence either of the (acidic) sulfonic acid group —SO₃H or of its salt —SO₃M (M=metal, ammonium).

Organic pigments are obtained from the synthesis frequently in a coarsely crystalline form with a highly heterogeneous particle size distribution. For conversion into a coloristically valuable pigment form suitable for the application, therefore, the crude pigments are typically subjected to a finishing procedure.

Known for these purposes is the grinding of the crude pigment and subsequent recrystallization of the ground material from an organic solvent, or else the grinding is carried out as wet grinding in aqueous suspension in high-speed agitated ball mills. Albeit in some cases after a good deal of time, the methods described do achieve particle comminution and hence an improvement in the coloristic properties of the pigments, but the particle size of the pigments obtained is difficult to control, and the pigments frequently have an inadequate—that is, excessively broad—particle size distribution for a series of applications, as colorants in inkjet inks, for example.

WO 02/00643 discloses a method of finishing crude quinophthalone pigments by subjecting the as-synthesized crude pigment to grinding in the absence of grinding assistants and then crystallizing the ground material obtained, in the presence of a quinophthalone derivative, in an organic solvent or in a mixture of organic solvent and water. Derivatives specified include, for example, sulfonic acid derivatives of the quinophthalone pigments.

WO 2004/048482 discloses a method of finishing organic pigments by dissolving the pigment in concentrated sulfuric acid and mixing the sulfuric acid solution with water in the presence of a crystallization modifier constituted by a condensation product of naphthalenesulfonic acid and formaldehyde. In that case the crystallization modifier is added before the sulfuric acid pigment solution is mixed, or is generated in said solution in situ by reaction of 1- and 2-naphthalenesulfonic acid with formaldehyde. A disadvantage of this in situ synthesis is that it results in condensation products having a broad and poorly defined molecular weight distribution.

It is an object of the invention to provide an advantageous and easy-to-implement method of finishing organic pigments that produces pigments having very good coloristic properties.

This object is achieved by means of a method of finishing an organic pigment by dissolving or dispersing the pigment in a mineral acid and crystallizing the pigment from the solution or dispersion by mixing with an aqueous diluent in the presence of a crystallization modifier constituted by a sulfonate-functional condensation product of a naphthalenesulfonic acid and at least one aliphatic aldehyde having 1 to 6 carbon atoms, and then isolating the pigment as a solid, wherein the crystallization modifier is added with the aqueous diluent.

Since the crystallization modifier is present in the aqueous diluent and not in the sulfuric acid pigment solution, the size of the pigment particles can be controlled more effectively.

The crystallization modifier is a condensation product of one or more naphthalenesulfonic acids, which may contain one or more sulfonic acid groups—preferably of 1-naphthalenesulfonic acid, 2-naphthalenesulfonic acid or mixtures thereof—and one or more different aliphatic aldehydes having 1 to 6 carbon atoms. Preference is given to mixtures of 1-naphthalenesulfonic acid and 2-naphthalenesulfonic acid, in a molar ratio, for example, of 4:1. Generally speaking, condensation takes place with 0.5 to 2 mol of aliphatic aldehyde per mole of naphthalenesulfonic acid present; with particular preference this molar ratio is approximately 1:1.

A preferred aliphatic aldehyde is formaldehyde. With particular preference formaldehyde only is used.

Generally speaking, the naphthalenesulfonic acids are prepared by sulfonating naphthalene with concentrated sulfuric acid or oleum. In the course of this preparation, polysulfonated products and/or sulfones may also be formed to a minor extent, and, accordingly, may also be comprised in the condensation products.

The crystallization modifier, which is generally a commercial product and is preferably in the form of a concentrated aqueous solution, is simply mixed into the aqueous diluent. Mixing with concentrated sulfuric acid, which is not entirely unobjectionable from a safety standpoint, is unnecessary in accordance with the invention.

The naphthalenesulfonic acid-aldehyde condensates used as crystallization modifiers in accordance with the invention generally have an average molecular weight <20 000 g/mol, preferably <10 000 g/mol, more preferably from 500 to 15 000 g/mol, and in particular from 1000 to 10 000 g/mol. The atomic ratio of sulfur to carbon is preferably at least 1:11. Condensation products of this kind are also available commercially.

By way of example a suitable naphthalenesulfonic acid-formaldehyde condensate can be prepared as follows:

1 to 3 parts by weight of naphthalene are sulfonated with 1 to 3 parts by weight of a sulfuric acid having a concentration of 85% to 100% by weight or of oleum having a free SO₃ content of 2% to 45% by weight. The sulfonation can be carried out at temperatures from 80 to 190° C.; the reaction times are from 0.5 to 10 hours. For the sulfonation, auxiliaries such as boric acid may be present, preferably in a concentration of 0.5% to 5% by weight, relative to sulfuric acid or oleum. After the sulfonation the reaction mixture is diluted with 0.5 to 2 parts of water and then condensed with 0.3 to 1.8 parts of aqueous formaldehyde solution having a formaldehyde concentration of 20% to 40% by weight, at a temperature of 80 to 180° C. The condensation mixture is subsequently diluted with up to 0.5 parts of water and is adjusted using aqueous sodium hydroxide solution to a pH of 4 to 10. Finally, the condensation mixture is again diluted with 0.5 parts of water, aqueous sodium hydroxide solution and milk of lime are added, and precipitating CaSO₄ is removed by filtration. The pH is subsequently adjusted to a figure between 4 and 10. Lastly, using water, the final concentration of 15% to 50% by weight solids content is set.

The condensation product acts in general as a crystallization inhibitor.

In the finishing method of the invention the organic pigment is dissolved or dispersed in a mineral acid and is crystallized from the solution or dispersion by dilution with an aqueous diluent in the presence of the crystallization modifier. A preferred mineral acid is sulfuric acid. In particular the pigment is dissolved in concentrated sulfuric acid. When the mineral acid pigment solution is mixed with the aqueous diluent, the crystallization modifier is present in the aqueous diluent. In one preferred version of this method, mixing is accomplished by combining the mineral acid pigment solution and the aqueous diluent, comprising the crystallization modifier, by means of a mixing nozzle. The aqueous diluent is generally water. Crystallization can also take place by pouring the mineral acid pigment solution into the aqueous diluent - preferably ice-water.

In another version of this embodiment the crystallized organic pigment, after crystallization, can be aged in the presence of a surfactant. The surfactant may be added to the aqueous diluent itself or may be added after the crystallization step of the pigment suspension, generally in the form of an aqueous solution. Aging the crystallized organic pigment occurs generally by stirring of the pigment suspension at temperatures of in general 40 to 100° C. for a period of 0.5 to 5 h. In the course of this aging, larger pigment particles grow at the expense of smaller pigment particles and/or there is smoothing/healing of the crystal surface of the pigment particles. Given that operation takes place in the presence of a surfactant, this process takes place in the aqueous sulfuric acid pigment suspension even with a comparatively low sulfuric acid content, in other words in the suspension as present after the mixing of the sulfuric acid pigment solution with the aqueous diluent.

Suitable surfactants are the anionic, cationic, nonionic, and amphoteric surfactants specified below.

Generally speaking, the concentration of the pigment in the mineral acid pigment solution is 5% to 30% by weight. The crystallization modifier is used generally in amounts of 0.1% to 30% by weight, based on the pigment. The volume of the admixed aqueous diluent is generally 1 to 12 times the volume of the mineral acid pigment solution.

Examples of suitable pigments which can be finished by the method of the invention are azo, azomethine, methine, anthraquinone, phthalocyanine, perinone, perylene, diketopyrrolopyrrole, thioindigo, thiazineindigo, dioxazine, iminoisoindoline, iminoisoindolinone, quinacridone, flavanthrone, indanthrone, anthrapyrimidine, and quinophthalone pigments. Preferred pigments are phthalocyanine, perylene, quinacridone, indanthrone, and quinophthalone pigments, dioxazine and diketopyrrolopyrrole; particularly preferred pigments are phthalocyanine, perylene, and indanthrone pigments.

During the crystallization, the crystallization modifier used in accordance with the invention is present generally in amounts of 0.1% to 30%, preferably 0.3% to 25%, more preferably 1% to 22%, by weight, based on the pigment solution or pigment suspension. In certain cases it may be of advantage to make additional use of further crystallization modifiers, dispersants, surfactants or specific polymers. Examples of further crystallization modifiers are sulfonamides or pigment derivatives containing sulfonic acid groups, such as imidazolemethyl- or pyrazolemethyl-quinacridone-pigment sulfonic acids. These may be present during the precipitation step or not added until later on. Examples of suitable surfactants are anionic surfactants such as alkylbenzenesulfonates or alkylnaphthalenesulfonates or alkylsulfosuccinates, cationic surfactants such as quaternary ammonium salts, benzyltributylammonium chloride for example, or nonionic or amphoteric surfactants such as polyoxyethylene surfactants and alkyl or amidopropyl betaines. The surfactants may be present during the precipitation step or not added until later on.

Examples of suitable specific polymers are polyacrylic acid, polymethacrylic acid, polyurethanes, polyvinyl alcohol, polyvinylpyrrolidone or cellulose derivatives. They may be present during the precipitation step or not added until later on.

Optionally there may be various aftertreatment steps subsequently. In one embodiment of the method of the invention the pigment obtained by precipitation and isolated as a solid is dispersed in dilute aqueous sulfuric acid and swollen in the presence of the crystallization modifier. Prior to swelling, it is advantageous to grind the pigment together with the crystallization modifier, in an agitated ball mill, for example. The swelling causes the growth of larger pigment particles at the expense of smaller pigment particles and/or causes a smoothing/healing of the crystal surfaces of the pigment particles. Suitable dilute sulfuric acid generally has a concentration of 50% to 85%, preferably 60% to 85%, by weight. The swelling of the pigment in the dilute aqueous sulfuric acid in the presence of the crystallization modifier takes place in general at temperatures from 15 to 90° C. over a period of generally 0.5 to 24 hours. The optimum swelling conditions can be determined in preliminary tests for each kind of pigment. Subsequently, further dilution with water takes place. This is done, generally speaking, by adding 2 to 6 times the amount of water to the sulfuric acid pigment dispersion. Subsequently the diluted dispersion is stirred, generally for 0.5 to 2 hours more.

In another embodiment of the method of the invention, the pigment obtained by precipitation and isolated as a solid is dispersed in water and crystallized in the presence of the crystallization modifier and of a pigment solubility enhancer additive. Generally speaking, the solubility enhancer additive added is an organic solvent. Examples of suitable organic solvents include xylenes, glycols, alcohols, THF, acetone, NMP, DMF, and nitrobenzene. They are added generally in an amount of 0.1% to 50% by weight, based on the aqueous pigment suspension. The amount of crystallization modifier in this case is generally 0.1% to 30% by weight, based on the aqueous pigment suspension (without organic solvent). Generally speaking, the suspension is stirred in the presence of the organic solvent at temperatures in the range from 15° C. to boiling temperature, and then the organic solvent is removed by distillation. Alternatively the method can also be carried out without solvent, under elevated pressure. In that case, crystal growth of the pigment particles, controlled by the crystallization modifier, takes place by means of Ostwald ripening.

In all cases, the pigment crystallized in the presence of the crystallization modifier is subsequently isolated as a solid by filtration of the aqueous suspension.

Further finishing steps may follow. Thus, preferably, the pigment isolated as a solid is blended with a pigment synergist. This is generally an organic pigment derivative comprising sulfonate groups, generally a sulfonate-functional derivative of the aforementioned pigments. The pigment synergist is preferably the sulfonate-functional derivative of the pigment with which the synergist is blended. Generally speaking, the pigment synergist is used in amounts of 0.1% to 5% by weight, preferably 1% to 10% by weight, based on the completed pigment formulation.

The average particle size of the finished pigments is generally in the range from 10 to 400 nm, preferably 20 to 200 nm.

The pigments finished by the method of the invention may comprise the crystallization modifier on the surface of the pigment particles. Besides the pigment synergists already mentioned, the pigment preparations may comprise further additives, generally in amounts of up to 15% by weight. Examples of further additives include wetting agents, surfactants, antifoams, antioxidants, UV absorbers, stabilizers, plasticizers, and texturing assistants.

The invention is elucidated in greater detail by the examples which follow.

### EXAMPLES

The pigment preparations according to the invention are tested in an aqueous varnish system.

For this purpose, first of all an aqueous tinting paste is prepared on the basis of a water-dilutable polyurethane resin. 100 g of the polyurethane resin dispersion described in Example 1.3 of WO-A-92/15405, 30 g of the pigment preparation, and 50 g of water are suspended, the pH of the suspension is adjusted to 8 using dimethylethanolamine, and it is ground in a ball mill (charged with 1.0-1.6 mm SAZ beads [SAZ=silicon/aluminum/zirconium oxide]) for 4 h.

In step 2, 34 g of this aqueous tinting paste (15% by weight based on pigment) are added to 225 g of a polyurethane-based mixing varnish (described in Example 3 of WO-A 92/15405). Following the addition of 7.5 g of water, a pH of 8 is set using aminoethanol. The resulting suspension is stirred for 15 minutes using a propeller stirrer at 1000 rpm.

On the basis of the aqueous basecoat materials prepared, metallic paints are produced and are applied by spraying.

The crystallization modifier used was Tamol® NN9401, a naphthalenesulfonic acid/formaldehyde condensation product having a molecular weight in the range from 5000 to 10 000 g/mol.

### Example 1

140 parts of perylene-3,4,9,10-tetracarboxylic N,N′-dimethyldiimide (C.I. Pigment Red 179) are dissolved in 2576 parts of sulfuric acid (96%) and the solution is conditioned at 25° C. The pigment preparation is subsequently precipitated from the acid using a solution at 25° C. of 19.2 parts of a naphthalenesulfonic acid-formaldehyde condensation product in 10 000 parts of water, by nozzle precipitation using a Y-shaped nozzle (0.5 mm holes for the reactant streams), with the following precipitation parameters: water supply rate 400 g/min, pigment solution supply rate 100 g/min. After an initial period of 3 minutes without and 3 minutes with regulation of the supply rates, the suspension is isolated and the pigment is filtered, washed, and dried.

This gives a pigment preparation which, in an aqueous varnish system based on a water-dilutable polyurethane resin, yields a strongly colored, transparent coating with a yellowish red hue. The metallic coating is strongly colored and bright.

### Example 2

50 parts of pigment preparation 1 are ground together with 3.75 parts of a perylene compound containing sulfonic acid groups (prepared according to Example 3 of EP 0 486 531 B1). The metallic coating of this pigment preparation is even more transparent and more yellow than pigment preparation 1.

### Example 3

1000 parts of the suspension of pigment preparation 1 are admixed with 2.56 parts of a beta-naphthol ethoxylate (Lugalvan BNO 12, BASF) and the mixture is stirred at 60° C. for 5 hours. Thereafter the pigment preparation is filtered through a suction filter and the solid product is washed to <100 μS (conductivity of the wash water), dried under reduced pressure in a drying cabinet at 80° C., and ground.

50 parts of this pigment preparation are ground together with 3.75 parts of a perylene compound containing sulfonic acid groups (prepared according to Example 3 of EP 0 486 531 B1). With high transparency and a yellowish red hue in the metallic coating, the aqueous varnish system based on a water-dilutable polyurethane resin has a lower viscosity than that from pigment preparation 2.

1. A method of finishing an organic pigment, comprising: dissolving the pigment in a mineral acid; crystallizing the pigment from the acid by mixing with an aqueous diluent comprising a crystallization modifier comprising a sulfonate-functional condensation product wherein the product comprises a naphthalenesulfonic acid and at least one aliphatic aldehyde having 1 to 6 carbon atoms; and then isolating the pigment as a solid.

2. The method according to claim 1, wherein the aliphatic aldehyde is formaldehyde.

3. The method according to claim 1, wherein the naphthalenesulfonic acid is a mixture of 1- and 2-naphthalenesulfonic acid.

4. The method according to claim 1, wherein the organic pigment is dissolved in concentrated sulfuric acid.

5. The method according to claim 1, wherein said mixing with the aqueous diluent is carried out by a mixing nozzle.

6. The method according to claim 1, comprising aging the crystallized organic pigment in the presence of a surfactant before said isolating the pigment as a solid.

7. The method according to claim 6, wherein the surfactant is present in the aqueous diluent or added after the crystallization.

8. The method according to claim 1, wherein the pigment isolated as a solid is dispersed in water and is crystallized in the presence of the crystallization modifier and of a pigment solubility enhancer additive.

9. The method according to claim 8, wherein the pigment solubility enhancer additive is selected from the group consisting of xylenes, glycols, alcohols, THF, acetone, NMP, DMF, and nitrobenzene.

10. The method according to claim 1, wherein the pigment isolated as a solid is dispersed in dilute aqueous sulfuric acid and swollen in the presence of the crystallization modifier.

11. The method according to claim 1, wherein the pigment isolated as a solid is blended with a pigment synergist which is a derivative comprising sulfonate or carbonate groups or is a basic derivative of an organic pigment.

12. The method according to claim 11, wherein the pigment synergist is a derivative of the pigment.

13. The method according to claim 1, wherein the pigment is selected from the group consisting of azo, azomethine, methine, anthraquinone, phthalocyanine, perinone, perylene, diketopyrrolopyrrole, thioindigo, thiazineindigo, dioxazine, iminoisoindoline, iminoisoindolinone, quinacridone, flavanthrone, indanthrone, anthrapyrimidine, and quinophthalone pigments.
